(19) United States
(12) Patent Application Publication
(10) Pub. No.: US 2008/0120283 A1
(43) Pub. Date: May 22, 2008

(54) Processing XML data stream(s) using continuous queries in a data stream management system

(75) Inventors: Zhen Hua Liu, San Mateo, CA (US); Shailendra K. Mishra, Fremont, CA (US); Muralidhar Krishnaprasad, Fremont, CA (US)

Correspondence Address: Silicon Valley Patent Group LLP, 18805 Cox Avenue, SUITE 220, Saratoga, CA, 95070, US

(73) Assignee: Oracle International Corporation, Redwood Shores, CA (US)

(21) Appl. No.: 11/601,415

(22) Filed: Nov. 17, 2006

(51) Int. Cl. G06F 17/30

(52) U.S. Cl. 707/4; 707/E17.014

(57) ABSTRACT

A computer is programmed to accept queries over streams of, data structured as per a predetermined syntax (e.g. defined in XML). The computer is further programmed to execute such queries continually (or periodically) on data streams of tuples containing structured data that conform to the same predetermined syntax. In many embodiments, the computer includes an engine that exclusively processes only structured data, quickly and efficiently. The computer invokes the structured data engine in two different ways depending on the embodiment: (a) directly on encountering a structured data operator, or (b) indirectly by parsing operands within the structured data operator which contain path expressions, creating a new source to supply scalar data extracted from structured data, and generating additional trees of operators that are natively supported, followed by invoking the structured data engine only when the structured data operator in the query cannot be fully implemented by natively supported operators.

### CROSS-REFERENCE TO RELATED APPLICATIONS

This application is related to and incorporates by reference herein in its entirety, a commonly-owned U.S. application Ser. No. 10/948,523, entitled “EFFICIENT EVALUATION OF QUERIES USING TRANSLATION” filed on Aug. 6, 2004 by Zhen H. Liu et al., Attorney Docket No. 50277-2573.

### BACKGROUND

It is well known in the art to process queries over data streams using one or more computer(s) that may be called a data stream management system (DSMS). Such a system may also be called an event processing system (EPS) or a continuous query (CQ) system, although in the following description of the current patent application, the term “data stream management system” or its abbreviation “DSMS” is used. DSMS systems typically receive a query (called “continuous query”) that is applied to a stream of data that changes over time rather than static data that is typically found stored in a database. Examples of data streams are real time stock quotes, real time traffic monitoring on highways, and real time packet monitoring on a computer network such as the Internet. FIG. 1A illustrates a prior art DSMS built at the Stanford University, in which data streams from network monitoring can be processed, to detect intrusions and generate online performance metrics, in response to queries (called “continuous queries”) on the data streams. Note that in such data stream management systems, each stream of data can be infinitely long and hence the amount of data is too large to be persisted by a database management system (DBMS) into a database.

As shown in FIG. 1B a prior art DSMS may include a query compiler that receives a query, builds an execution plan which consists of a tree of natively supported operators, and uses it to update a global query plan. The global query plan is used by a runtime engine to identify data from one or more incoming stream(s) that matches a query and based on such identified data to generate output data, in a streaming fashion.

As noted above, one such system was built at Stanford University in a project called the Standford Stream Data Management (STREAM) Project which is documented at the URL obtained by replacing the ? character with “/” and the % character with “.” in the following: http:??www-db%stanford%edu?stream. For an overview description of such a system, see the article entitled “STREAM: The Stanford Data Stream Management System” by Arvind Arasu, Brian Babcock, Shivnath Babu, John Cieslewicz, Mayur Datar, Keith Ito, Rajeev Motwani, Utkarsh Srivastava, and Jennifer Widom which is to appear in a book on data stream management edited by Garofalakis, Gehrke, and Rastogi and available at the URL obtained by making the above described changes to the following string: http:??dbpubs%stanford%edu?pub?2004-20. This article is incorporated by reference herein in its entirety as background.

For more information on other such systems, see the following articles each of which is incorporated by reference herein in its entirety as background:
[a]S. Chandrasekaran, O. Cooper, A. Deshpande, M. J. Franklin, J. M. Hellerstein, W. Hong, S. Krishnamurthy, S. Madden, V. Ramna, F. Reiss, M. Shah, “TelegraphCQ: Continuous Dataflow Processing for an Uncertain World”, Proceedings of CIDR 2003;
[b] J. Chen, D. Dewitt, F. Tian, Y. Wang, “NiagaraCQ: A Scalable Continuous Query System for Internet Databases”, PROCEEDINGS OF 2000 ACM SIGMOD, p 379-390; and
[c] D. B. Terry, D. Goldberg, D. Nichols, B. Oki, “Continuous queries over append-only databases”, PROCEEDINGS OF 1992 ACM SIGMOD, pages 321-330.

Continuous queries (also called “persistent” queries) are typically registered in a data stream management system (DSMS), and can be expressed in a declarative language that can be parsed by the DSMS. One such language called “continuous query language” or CQL has been developed at Stanford University primarily based on the database query language SQL, by adding support for real-time features, e.g. adding data stream S as new data type based on a series of (possibly infinite) time-stamped tuples. Each tuple s belongs to a common schema for entire data stream S and the time t increases monotonically. Note that such a data stream can contain 0, 1 or more paris each having the same (i.e. common) time stamp.

Stanford's CQL supports windows on streams (derived from SQL-99) which define “relations” as follows. A relation R is an unordered bag of tuples at any time instant t which is denoted as R(t). The CQL relation differs from a relation of a standard relational model used in SQL, because traditional SQL's relation is simply a set (or bag) of tuples with no notion of time. All stream-to-relation operators in CQL are based on the concept of a sliding window over a stream: a window that at any point of time contains a historical snapshot of a finite portion of the stream. Syntactically, sliding window operators are specified in CQL using a window specification language, based on SQL-99.

For more information on Stanford's CQL, see a paper by A. Arasu, S. Babu, and J. Widom entitled “The CQL Continuous Query Language: Semantic Foundation and Query Execution”, published as Technical Report 2003-67 by Stanford University, 2003 (also published in VLDB Journal, Volume 15, Issue 2, June 2006, at Pages 121-142). See also, another paper by A. Arasu, S. Babu, J. Widom, entitled “An Abstract Semantics and Concrete Language for Continuous Queries over Streams and Relations”, In 9th Intl Workshop on Database programming languages, pages 1-11, September 2003. The two papers described in this paragraph are incorporated by reference herein in their entirety as background.

An example to illustrate continuous queries is shown in FIGS. 1C-1E which are reproduced from the VLDB Journal paper described in the previous paragraph. Specifically, FIG. 1E illustrates a merged STREAM query plan for two continuous queries, Q1 and Q2 over input streams S1 and S2. Query Q1 is shown in FIG. 1C expressed in CQL as a windowed-aggregate query: it maintains the maximum value of S1:A for each distinct value of S1:B over a 50,000-tuple sliding window on stream S1. Query Q2 shown in FIG. 1D is expressed in CQL and used to stream the result of a sliding-window join over streams S1 and S2. The window on S1 is a tuple-based window containing the last 40,000 tuples, while the window on S2 is a 10-minutes time-based window.

In Stanford's CQL, a tuple s may contain any scalar SQL datatype, such as VARCHAR, DECIMAL, DATE, and TIMESTAMP datatypes. To the knowledge of the inventors of the current patent application (1) Stanford's CQL does not recognize structured data types, such as the XML type and (2) there appears to be no prior art suggestion to extend CQL to support the XML type. Hence, it appears that the CQL language as defined at Stanford University cannot be used to query information in streams of structured data, such as streams of orders and fulfillments that may have several levels of hierarchy in the data.

The inventors of the current patent application believe that extending CQL to support XML is advantageous for such applications, because XML provides a common syntax for expressing structure in data. Structured data refers to data that is tagged for its content, meaning, or use. XML tags identify XML elements and attributes or values of XML elements. XML elements can be nested to form hierarchies of elements. An XML document can be navigated using an XPath expression that indicates a particular node of content in the hierarchy of elements and attributes. XPath is an abbreviation for XML Path Language defined by a W3C Recommendation on 16 Nov. 1999, as described at the URL obtained by modifying the following string in the above-described manner: http:??www%w3%org?TR?xpath.

Use of XPath expressions in the database query language SQL is well known, and is described in, for example, “Information Technology—Database Language SQL-Part 14: XML Related Specifications (SQL/XML)”, part of ISO/IEC 9075, by International Organization for Standardization (ISO) available at the URL obtained by modifying the following string as described above: http:??www%sqlx%org?SQL-XML-documents?5WD-14-XML-2003-12%pdf. This publication is incorporated by reference herein in its entirety as background. See also an article entitled “Efficient XSLT Processing in Relational Database System” published by at Zhen Hua Liu and Agnuel Novoselsky in Proceedings of the 32nd international conference on Very Large Data Bases (VLDB), pages 1106-1116, published September 2006 which is also incorporated by reference herein in its entirety as background. Note that the articles mentioned in this paragraph relate to use of XML in traditional databases, and not to processing of data streams that contain structured data expressed in XML.

For information on processing XML data streams, see an article by S. Bose, L. Fegaras, D. Levine, V. Chaluvadi entitled “A Query Algebra for Fragmented XML Stream Data” In the 9th International Workshop on Data Base Programming Languages (DBPL), Potsdam, Germany, September 2003. This article is incorporated by reference herein in its entirety as background. Bose's article discusses query algebra for fragmented XML stream data. This article views XML stream as a sequence of management chunks and hence it provides an intra-XQuery Sequence Data Model stream, without suggesting the invention as discussed below in the next several paragraphs of the current patent application. Moreover, although the above-described paper on NiagaraCQ by J. Chen et al. discusses XML-QL, an early version of XQuery, it too does not propose an XML extension to a CQL kind of language. Finally, a PhD thesis entitled “Query Processing for Large-Scale XML Message Brokering” by Yanlei Diao, published in Fall 2005 by University of California Berkeley is incorporated by reference herein in its entirety as background. This thesis describes a system called YFilter to provide support for filtering XML messages. However, Yfilter requires the user to write up queries in XQuery, i.e. the XML Query language, and it does not appear to support a CQL-kind of language.

### SUMMARY

One or more computer(s) are programmed in accordance with the invention, to accept queries over streams of data, at least some of the data being structured as per a predetermined syntax (e.g. defined in an extensible markup language). The computer(s) is/are further programmed to execute such queries continually (or periodically) on data streams of tuples containing structured data that conform to the same predetermined syntax. A DSMS that is extended in either or both of the ways just described is also referred to below as “extended” DSMS.

In many embodiments, an extended DSMS includes an engine that exclusively processes documents of structured data, quickly and efficiently. The DSMS invokes the just-described engine in at least two different ways, depending on the embodiment. One embodiment of the invention uses a black box approach, wherein any operator on the structured data is passed directly to the engine (such as an XQuery runtime engine) which evaluates the operator in a functional manner and returns a scalar value, and the scalar value is then processed in the normal manner of a traditional DSMS.

An alternative embodiment uses a white box approach wherein paths in a continuous query that traverse the structured data (such as an XPath expression) are parsed. The alternative embodiment also creates a new source to supply scalar data that is extracted from the structured data, and also generates an additional tree for an expression in the original query that operates on structured data, using scalar data supplied by said new source. At this stage the additional tree uses operators that are natively supported in the alternative embodiment. Thereafter, an original tree of operators representing the query is modified by linking the additional tree, to yield a modified tree, followed by generating a plan for execution of the query based on the modified tree. Note that the alternative embodiment invokes the structured data engine if any portion of the original query has not been included in the modified tree.

Unless described otherwise, an extended DSMS of many embodiments of the invention processes continuous queries (including queries conforming to the predetermined syntax) against data streams (including tuples of structured data conforming to the same predetermined syntax) in a manner similar or identical to traditional DSMS.

### BRIEF DESCRIPTION OF THE DRAWINGS

FIGS. 1A and 1B illustrate, in a high level diagram and an intermediate level diagram respectively, a data stream management system of the prior art.

FIGS. 1C and 1D illustrate two queries expressed in a continuous query language (CQL) of the prior art.

FIG. 1E illustrates a query plan of the prior art for the two continuous queries of FIGS. 1C and 1D.

FIG. 2 illustrates, in an intermediate level diagram, an extended data stream management system in accordance with the invention.

FIG. 3 and FIG. 4 illustrate, in flow charts, two alternative methods that are executed by query compilers in certain embodiments of the extended data stream management system of FIG. 2.

FIG. 5 illustrates, in a high level block diagram, hardware included in a computer that may be used to perform the methods of FIGS. 3 and 4 in some embodiments of the invention.

FIG. 6 illustrates an operator tree and stream source that are created by a query compiler on compilation of a continuous query in accordance with the invention.

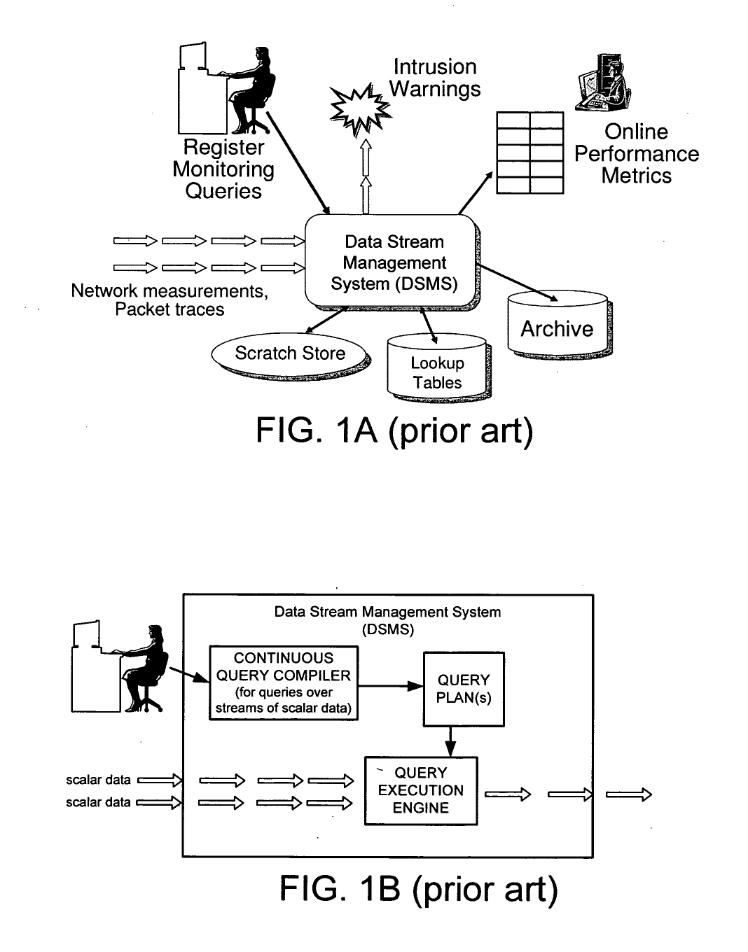

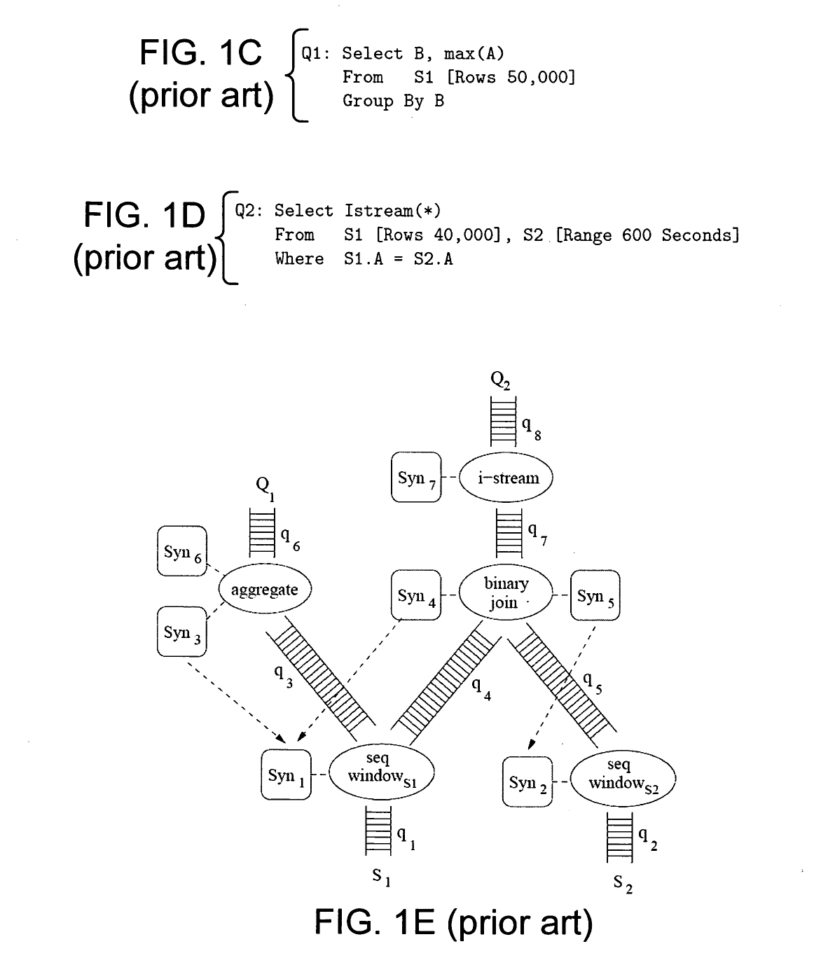

### DETAILED DESCRIPTION

Many embodiments of the invention are based on an extensible markup language in conformance with a language called “XML” defined by W3C, and based on SGML (ISO 8879). Accordingly, an extended DSMS of several embodiments supports use of XML type as an element in a tuple of a data stream (also called “structured data stream”). Hence each tuple in a data stream that can be handled by several embodiments of an extended DSMS (also called XDSMS) as described herein may include XML elements, XML attributes, XML documents (which always have a single root element), and document fragments that include multiple elements at the root level.

Accordingly, an extended DSMS in many embodiments of the invention supports an XML extension to any continuous query language (such as Stanford University's CQL), by accepting XML data streams and enabling a user to use native XML query languages, such as XQuery, XPath, XSLT, in continuous queries, to process XML data streams. Hence, the extended DSMS of such embodiments enables a user to use industry-standard definitions of XQuery/XPath/XSLT to query and manipulate XML values in data streams. More specifically, an extended DSMS of numerous embodiments supports use of structured data operators (such as XMLExists, XMLQuery and XMLCast currently supported in SQL/XML) in any continuous query language to enable declarative processing of XML data in the data streams.

A number of embodiments of an extended DSMS support use of a construct similar or identical to the SQL/XML construct XMLTable, in a continuous query language. A DSMS's continuous query language that is being extended in many embodiments of the invention natively supports certain standard SQL keywords, such as a SELECT command having a FROM clause as well as windowing functions required for stream and/or relation operations. Note that even though the same keywords and/or syntax may be used in both SQL and CQL, the semantics are different because SQL operates on stored data in a database whereas CQL operates on transient data in a data stream. Finally, various embodiments of an extended DSMS also support SQL/XML publishing functions in CQL to enable conversion between an XML data stream and a relational data stream.

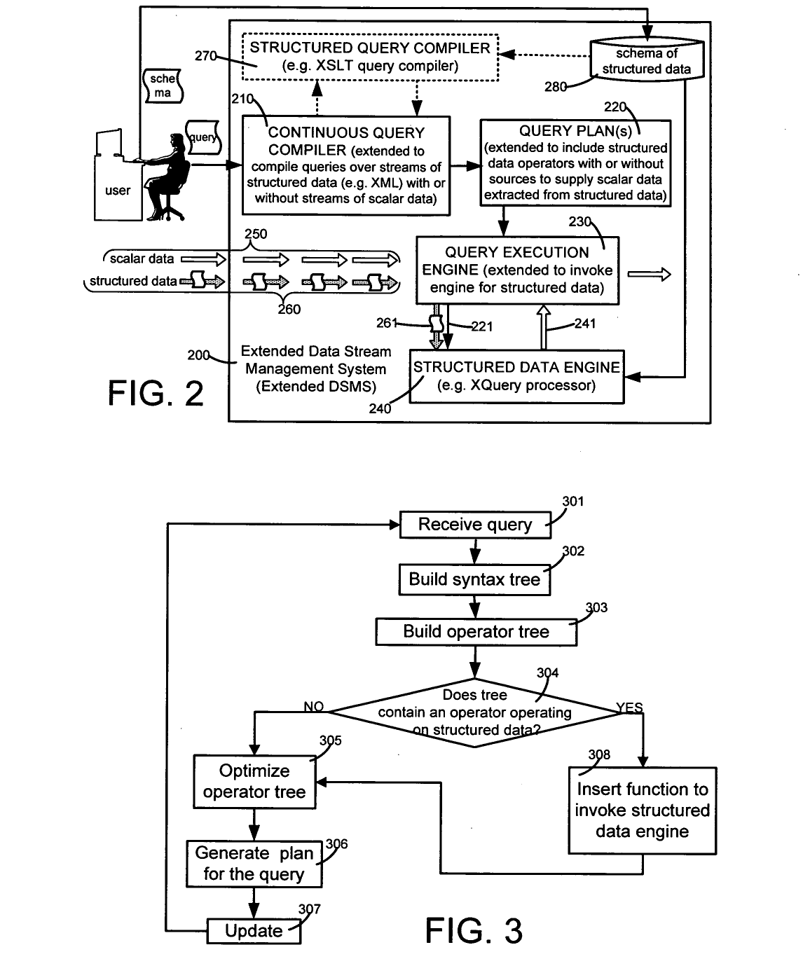

In many embodiments, an extended DSMS 200 (FIG. 2) includes a computer that has been programmed with a structured data engine 240 which quickly and efficiently handles structured data. The manner and circumstances in which the structured data engine 240 is invoked differs, depending on the embodiment. One embodiment uses a black box approach wherein any XML operator is passed directly to engine 240 during normal operation whenever it needs to be evaluated, whereas another embodiment uses a white box approach wherein path expressions within a query that traverse structured data are parsed during compile time and where possible converted into additional trees of operators that are natively supported, and these additional trees are added to a tree for the original query.

In the black box approach, a query compiler 210 in the extended DSMS receives (as per act 301 in FIG. 3) a continuous query and parses (as per act 302 in FIG. 3) the continuous query to build an abstract syntax tree (AST), followed by building an operator tree (as per act 303 in FIG. 3) including one or more stream operators that operate on a scalar data stream 250 or a structured data stream 260 or a combination of both streams 250 and 260. An operator on structured data is recognized in act 304 of some embodiments based on presence of certain reserved words in the query, such as XMLExists which are defined in the SQL/XML standard.

The presence of reserved words (of the type used in the SQL/XML standard) indicates that the continuous query requires performance of operations on data streams containing data which has been structured in accordance with a predetermined syntax, as defined in, for example an XML schema document. The absence of such reserved words indicates that the continuous query does not operate on structured data stream(s), in which case the continuous query is further compiled by performing acts 305 (to optimize the operator tree), 306 (generate plan for the query) and 307 (update the plan currently used by the execution engine). Acts 305-307 are performed as in a normal DSMS.

If the continuous query contains a structured data operator (e.g. in an XPath expression), at compile time query compiler 210 inserts (as per act 308 in FIG. 3) in the operator tree for the continuous query (which tree is an in-memory representation of the query) a function to invoke structured data engine 240 (which contains a processor for the structured data operator). Note that at run time, structured data engine 240 uses schema of structured data from a persistent store 280 which schema is stored therein by the user who then issues to query compiler 210 a continuous query on a stream of structured data. In this manner, all structured data operators in the continuous query are processed by the extended DSMS 200 without significant changes to a continuous query execution engine 230 present in the extended DSMS 200 (note that engine 230 is changed by programming it to invoke engine 240 when it encounters the just-described function which is inserted by query compiler 210).

Hence, as noted above, acts 305-307 are performed in the normal manner to prepare for execution of the continuous query, except that invocations to the structured data engine 240 are appropriately included when these acts are performed. Hence, at run time, during execution of the continuous query, in response to receipt of structured data in a data stream, a query execution engine 230 invokes structured data engine 240 in a functional manner, to process operators on structured data that are present in the continuous query. When invoked, engine 240 receives an identification of the structured data operator (as shown by bus 221) and structured data (as shown by bus 261), as well as schema from store 280 and returns a scalar value (as shown by bus 241). The scalar value on bus 241 returned by engine 240 is used by query execution engine 230 in the normal manner to complete processing of the continuous query.

Operation of the black box embodiment is now illustrated with an example query as follows:

SELECT RStream(count(*))
FROM StockTradeXMLStream AS sx
[RANGE 1 Hour SLIDES 5 minutes]
WHERE XMLExists(
‘/StockExchange/TradeRecord[TradeSymbol = “ORCL” and
TradePrice >= 14.00 and TradePrice <= 16.00]’ PASSING VALUE(sx))

Query execution engine 230 when programmed in the normal manner, can execute the SELECT, the FROM and the WHERE clauses of the above query. However, in executing the WHERE clause, engine 230 encounters an XML operator, namely XMLExists which receives as its input an XPath expression from the query and also the XML data from a stream which is a value “sx” supplied by the FROM clause. Accordingly, in the black box embodiment, engine 230 passes both these inputs along path 261 (see FIG. 2) to engine 240 that natively operates on structured data.

In another example, the XML operator XMLExists described above in paragraph [0031] can be used to write the following CQL/XML query to keep a count of all trading records on Oracle stock with price greater than $32 in the last hour, with the count being updated once every 5 minutes starting from Nov. 10, 2006:

SELECT count(*)
FROM inputTradeXStream [RANGE 60 minutes,
SLIDE 5 minutes, START AT ‘2006-11-10’] s
WHERE XMLExists(‘/tradeRecord[symbol = “ORCL” and
price > 32]’ PASSING s.value)

Note that engine 240 which executes the XMLExists operator takes an XMLType value and an XQuery as inputs and applies the XQuery on the XMLType value to see if it evaluates to a non-empty sequence result. If the result is non-empty sequence, then it is TRUE, FALSE otherwise.

Engine 240 (FIG. 2) is implemented in some embodiments by an XQuery runtime engine. The XQuery runtime engine returns a Boolean value (i.e. TRUE or FALSE). Hence, if the XQuery runtime engine returns TRUE then this result means that in this XML data there is a trade symbol ORCL and its price is between 14 and 16. This Boolean value is returned (as shown by arrow 241 in FIG. 2) back to continuous query execution engine 230, for further processing in the normal manner.

To summarize features of the black box embodiment, extended DSMS 200 includes a structured data engine 240 and its query compiler 210 has been extended to allow use of one or more operators supported by the structured data engine 240, and query execution engine 230 automatically invokes structured data engine 240 on encountering structured data to be evaluated for a query.

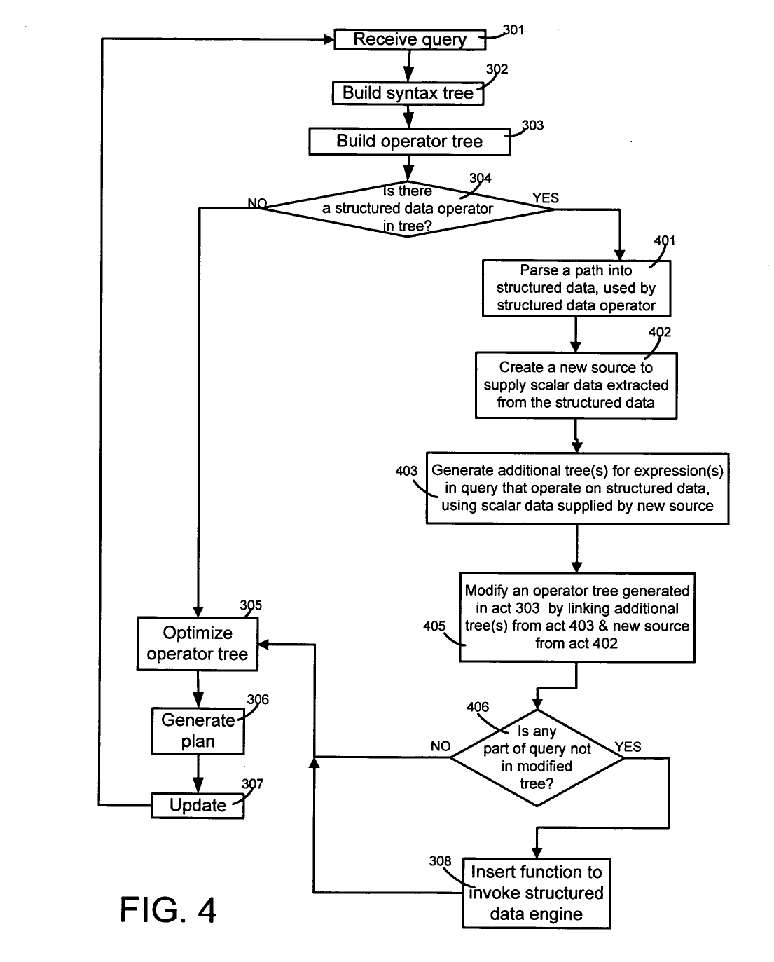

An alternative embodiment illustrated in FIG. 4 uses a white box approach wherein paths in the query that traverse the structured data (such as an XPath expression) are parsed. Note that many of the acts that are preformed in the alternative embodiment are same as the acts described above in reference to FIG. 3 and hence they are not described again. In the alternative embodiment, the structured data engine 240 is not directly invoked and instead, it is only invoked when the query contains expressions that cannot be implemented by operators that are natively supported in a DSMS. Specifically, in act 401, the query compiler parses a path into structured data (such as an XPath expression), which path is being used in an operand of the structured data operator. To do the parsing, the white box embodiments of DSMS include a structured query compiler 270, such as an XSLT query compiler. Note that this block 270 is shown with dotted lines in FIG. 2 because it is used in some white box embodiments but not in black box embodiments, and accordingly it is optional depending on the embodiment.

Thereafter, in act 402, the query compiler creates a new source of a data stream (such as a new source of rows of an XML table) to supply scalar data extracted from the structured data. Creation of such a new source is natively supported in the DSMS and is further described below in reference to FIG. 4B. The new source may be conceptually thought of as a table whose columns are predicates in expressions that traverse structured data. So, when data is fetched from such a table, it operates as an XML row source, so that an operator in the expression which receives such data interfaces logically to a row source—regardless of what's behind the row source.

Next, in act 403, the query compiler generates an additional tree for an expression in the continuous query that operates on structured data, using scalar data supplied by the new source. At this stage the additional tree uses operators that are natively supported in the DSMS. Thereafter, in act 405, an original tree of operators is modified by linking the additional tree, to yield a modified tree. At this stage, if any portion of the query has not been included in the modified tree (as per act 406), then an invocation of the structured data engine 260 in the original tree is retained. This is followed by acts 305-307 (FIG. 4) which are now based on the modified tree.

An XQuery processor used in engine 240 can be implemented in any manner well known in the art. Specifically, in certain black box embodiments, the XQuery processor constructs a DOM tree of the XML data followed by evaluating the XPath expression by walking through nodes in the DOM tree. In the example in paragraph [0031], the path to be traversed across structured data in an XML document is ‘/StockExchange/TradeRecord[TradeSymbol and so the XQuery processor takes the first node in the DOM tree and checks if its name is StockExchange and if yes then it checks the next node to see if its name is TradeRecord and if yes then it checks the next node down to see if its name is TradeSymbol and if yes, then it looks at the value of this node to check if it is ORCL. Hence, the routine engineering required to build such an XQuery processor is apparent to the skilled artisan in view of this disclosure.

For more information on XQuery processors, see, for example, a presentation entitled “Build your own XQuery processor!” by Mary Fernández et al, available at the URL obtained by modifying the following string in the above-described manner: http:??edbtss04%dia%uniroma3% it?Simeon%pdf. This document is incorporated by reference herein in its entirety. See also an article entitled “Implementing XQuery 1.0: The Galax Experience” by Mary Fernández et al, VLDB 2003 that is also incorporated by reference herein in its entirety. Moreover, see an article entitled “The BEA/XQRL Streaming XQuery Processor” by Daniela Florescu et al. VLDB 2003 that is also incorporated by reference herein in its entirety.

As noted above in reference to act 402 in FIG. 4, some embodiments of the extended DSMS create a source to supply a stream of scalar data as output based on one or more streams of structured data received as input. In an illustrative embodiment described herein, a continuous query language (CQL) is extended to support a construct called XMLTable. The XMLTable construct is used in some embodiments to build a source for supplying one or more streams of scalar data extracted from a corresponding stream of XML documents, as discussed in the next paragraph. The XMLTable converts each XML document it receives into a tuple of scalar values that are required to evaluate the query. This operation may be conceptually thought of as flattening of a hierarchical query into relations in an XML table.

Specifically, the example query in paragraph [0031] is flattened by query compiler 210 of some embodiments by use of an XMLTable construct as shown in the following CQL statement (which statement is not actually generated by query compiler 210 but is written below for conceptual understanding):

SELECT RStream(count(*))
FROM StockTradeXMLStream AS sx [RANGE 1 Hour SLIDES 5
minutes], XMLTable (‘/StockExchange/TradeRecord’ PASSING
VALUE(sx) COLUMNS TradeSymbol, TradePrice) S2
WHERE S2.TradeSymbol = “ORCL” and S2.TradePrice >= 14.00
and S2.TradePrice <= 16.00

### An operator tree for the expression in the WHERE clause of the above CQL statement is created in memory, by query compiler 210 in some white box embodiments of the invention, on compilation of the example query in paragraph

In such embodiments, at compile time, query compiler 210 also creates a source (denoted above as the construct XMLTable) for one or more stream(s) of scalar values which are supplied as data input to the just-described operator tree. FIG. 6 illustrates the just-described operator tree and stream source that are created by query compiler 210 on compilation of the example query in paragraph [0031], as discussed in more detail next.

At run time, the just-described stream source in this example receives as its input a stream 601 of XML documents, wherein each XML document contains a hierarchical description of a stock trade. The stream source 610 generates at its output two streams: one stream 602 of TradeSymbol values, and another stream 603 of TradePrice values. Note that although there may be other data embedded within the XML document, such data is not projected out by this stream source 610 because such data is not needed. The only data that is needed is specified in the COLUMNS clause of the XMLTable construct. Hence, these two streams 601 and 602 of scalar data that are projected out by the stream source 610 are operated upon by the respective operators in operator tree 620 which is illustrated in the expression in the WHERE clause shown above.

Hence, in many embodiments of the invention the XMLTable construct converts a stream of XMLType values into streams of relational tuples. XMLTable construct has two patterns: row pattern and column patterns, both of which are XQuery/XPath expressions. The row pattern determines number of rows in the relational tuple set and the column patterns determine the number of columns and the values of each column in each tuple set. A simple example shown below converts an input XML data stream into a relational stream. This example converts a data stream of single XMLType column tuple into a data stream of multiple column tuple, and each column value is extracted out from each XMLType column.

```
SELECT tradeReTup.symbol, tradeReTup.price, tradeReTup.volume
FROM inputTradeXStream [RANGE 60 miniutes, SLIDE 5 miniutes,
START AT ‘2006-05-10’] s, XMLTable(‘/tradeRecord’ PASSING s.value
COLUMNS
    Symbol varchar2(40) PATH ‘symbol’
    Price double PATH ‘price’
    Volume decimal(10,0) PATH ‘volume’) tradeReTup
```

Note XMLTable is conceptually a correlated join, its input is passed in from the stream on its left and its output is a derived relational stream. In this example, the input is a data stream of one hour window of data sliding at 5 minute interval starting from May 10, 2006. The output of the XML Table is a data stream of the same range, interval and starting time characteristics.

Note the cardinality of the XMLTable result per time window may not be the same as that of the cardinality of the input stream per time window although the cardinality is the same as in the above example. Here is an example which shows the cardinality difference. Suppose each XML document in the data stream is a purchaseOrder document with the following XML structures:

```
<purchaseOrder>
  <reference>XYZ446</reference>
  <shipAddress>Berkeley<shipAddress>
  <lineItem>
      <itemNo>34</itemNo>
    <itemName>CPU</itemName>
  </lineItem>
  <lineItem>
      <itemNo>34</itemNo>
    <itemName>CPU</itemName>
  </lineItem>
</purchaseOrder>
```

Note that each purchaseOrder document has a list of lineItem elements. Consider the following CQL/XML query:

```
Select lit.itemNo, lit.itemName
From inputPOStream [RANGE 60 miniutes, SLIDE 5 miniutes,
START AT ‘2006-05-10’] s, XMLTable(‘/PurchaseOrder/
lineItem’ PASSING s.value
    COLUMNS
      itemNo number PATH ‘itemNo’
      itemName varchar2(100) PATH ‘itemName’
      ) lit
```

In this query, the input is a stream of purchaseOrder XML documents. The query returns a relational tuple of item number, item name for an hour of purchaseOrder XML documents sliding at 5 minutes interval. If there are 300 purchaseOrder XML documents within past hour, there can be 900 rows of relational tuples implying that there are on average 3 line items per purchaseOrder documents.

Note that some embodiments of the invention flatten a continuous query on structured data as follows at compile time: build an abstract syntax tree (AST) of the query, and analyze the AST to see if an XML operator is being used and if true, then call an XSLT compiler to parse an XPath expression. The resulting tree from the XSLT compiler is used to extract a row pattern for the XMLTable, followed by converting each XPath step in the XPath predicate into a column of the XMLTable, followed by building an operator tree for the expression in the WHERE clause shown above (this operator tree is built in the normal manner of compiling a continuous query on scalar data).

Note that the examples in paragraphs [0031] and [0032] use the XML operator XMLExists as an illustration, and it is to be understood that other such XML operators are similarly supported by an extended DSMS in accordance with the invention. As an additional example, use of the XML operator XMLExtractvalue is described below as another illustration on how to use the construct XMLTable in continuous query compilation. Assume the following query is to be compiled:

SELECT XMLextractValue (‘po/customername’),
XMLextractValue (‘po/customerzip’)
FROM S

The query shown above is also flattened by query compiler 210 of some embodiments by use of the above-described XMLTable construct as shown in the following CQL statement (which statement is also not actually generated by query compiler 210 but is written below for conceptual understanding):

SELECT S2.customername, S2.customerzip
FROM S, XMLTable (‘po’, COLUMNS customername, customerzip) S2

As will be apparent to the skilled artisan, here again the original query's XPath expression has been replaced with the output of scalar values S2 generated by a row source that is created by use of the XMLTable construct. Accordingly, a query compiler 210 is programmed to convert any query that contains one or more XML operators into a tree of operators natively supported by the continuous query execution engine 230, by introducing the construct of XMLtable row source to output scalar values needed by the tree of operators.

Some embodiments of the invention extend CQL with various SQL/XML like operators, such as XMLExists( ), XMLQuery( ), and our extension operators, such as XMLExtractValue( ), XMLTransform( ) so that a user can use XPath/XQuery/XSLT to manipulate XML in the data stream. Furthermore, these embodiments also support SQL/XML publishing functions in CQL, such as XMLElement( ), XMLAgg( ) to construct XML stream from relational stream and XMLTable construct to construct relational stream over XML stream. These embodiments leverage the existing XML processing languages, such as XPath/XQuery/XSLT without modifying them. Furthermore, XMLExists( ), XMLQuery( ), XMLElement( ), XMLAgg( ) operators and XMLTable construct are well defined in SQL/XML, such embodiments leverage these pre-existing definitions by extending the semantics in CQL, to process XML data stream. Several of these operators are now discussed in detail, in the following paragraphs.

Some embodiments of a DSMS support use of the XML operator XMLQuery in CQL queries. Specifically, the operator XMLQuery takes the same input as the operator XMLExists (described above in paragraphs [0031] and [0032]) however XMLQuery returns an XQuery result sequence out as an XMLTye. The following query is similar to the query described in paragraph [0032], except that the following query returns the trading volume and the trading price as one XMLType fragment once every 5 minutes in the last hour.

SELECT XMLQuery( ‘(/tradeRecord/price, /tradeRecord/volume)’
PASSING s.value RETURNING content)
FROM inputTradeXStream [RANGE 60 minutes, SLIDE 5 minutes,
START AT ‘2006-05-10’] s
WHERE XMLExists(‘/tradeRecord[symbol = “ORCL” and price > 32]’
PASSING s.value)

As shown above, a user can query on XML documents embedded in the data stream and convert the XML document data stream into relational tuples stream. The user can also use XML generation functions, such as XMLElement, XMLForest, XMLAgg to generate an XML stream from relational tuple stream. Consider the example that the trading record data stream arrives as a relational stream with each tuple consisting of trading symbol, price and volume columns, then the user can write the following CQL/XML query which returns a stream of XML documents from a stream of relational tuples:

Select XMLElement(“tradeRecord”,
XMLForest(s.symbol, s.price, s.volume))
From inputTradeStream [RANGE 60 minutes, SLIDE 5 minutes,
START AT ‘2006-05-10’] s

If the input relational stream within last hour has 500 trading records, then the extended DSMS generates a stream consisting of 500 XML documents within last hour. However, we can use XMLAgg( ) to generate one XML document within last hour as shown below:

Select XMLAgg(XMLElement(“tradeRecord”,
XMLForest(s.symbol, s.price, s.volume))
From inputTradeStream [RANGE 60 minutes, SLIDE 5 minutes, START
AT ‘2006-05-10’] s

### Note XMLAgg is just like an aggregate, such as sum( ) and count( ) which aggregates all the inputs as one unit.

Several embodiments of the invention process XMLType value in the continuous data stream by extending CQL with XML operators. This enables users to declaratively process XMLType value in the data stream. The advantage of such embodiments is that they fully leverage existing XML processing languages, such as XPath/XQuery/XSLT and existing SQL/XML operators and constructs. These particular embodiments do not attempt to extend XPath/XQuery/XSLT to deal with XML data stream. Note however, that such embodiments are not restricted to DBMS servers, and instead may be used by application server in the middle tier. Moreover, XML extension to CQL language of the type described herein can be applied to any CQL query processors.

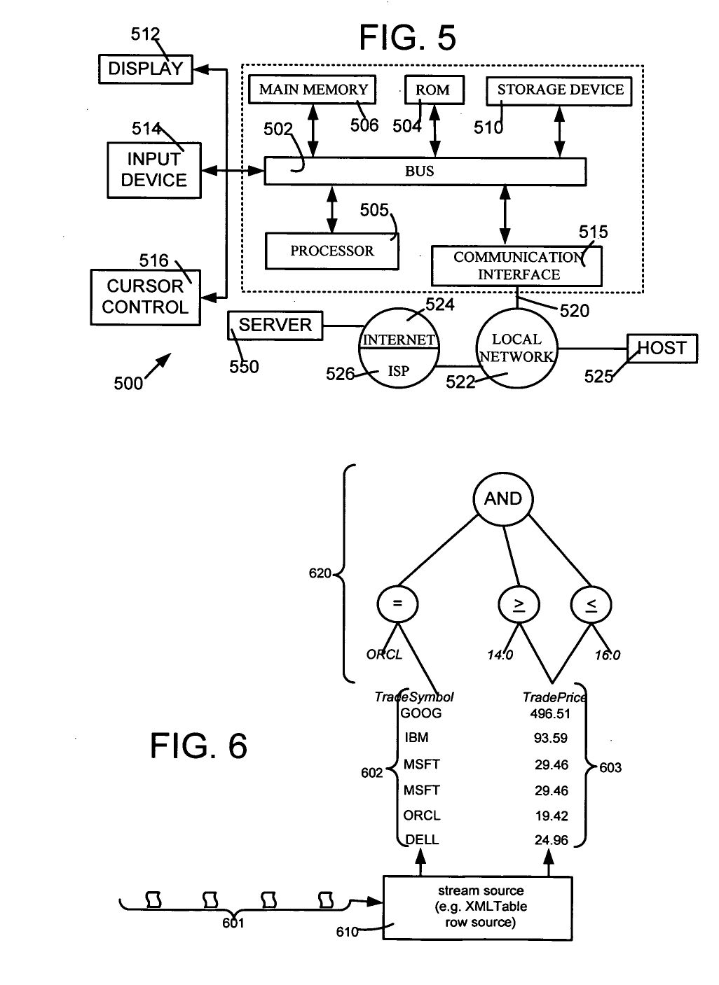

Note that data stream management system 200 may be implemented in some embodiments by use of a computer (e.g. an IBM PC) or workstation (e.g. Sun Ultra 20) that is programmed with an application server, of the type available from Oracle Corporation of Redwood Shores, Calif. Such a computer can be implemented by use of hardware that forms a computer system 500 as illustrated in FIG. 5. Specifically, computer system 500 includes a bus 502 (FIG. 5) or other communication mechanism for communicating information, and a processor 504 coupled with bus 502 for processing information.

Computer system 500 also includes a main memory 506, such as a random access memory (RAM) or other dynamic storage device, coupled to bus 502 for storing information and instructions to be executed by processor 504. Note that bus 502 of some embodiments implements each of buses 241, 261 and 221 illustrated in FIG. 2. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

As described elsewhere herein, incrementing of multi-session counters, shared compilation for multiple sessions, and execution of compiled code from shared memory are performed by computer system 500 in response to processor 504 executing instructions programmed to perform the above-described acts and contained in main memory 506. Such instructions may be read into main memory 506 from another computer-readable medium, such as storage device 510. Execution of instructions contained in main memory 506 causes processor 504 to perform the process steps described herein. In alternative embodiments, hard-wired circuitry may be used in place of or in combination with software instructions to implement an embodiment of the type illustrated in FIGS. 3 and 4. Thus, embodiments of the invention are not limited to any specific combination of hardware circuitry and software.

The term “computer-readable medium” as used herein refers to any medium that participates in providing instructions to processor 504 for execution. Such a medium may take many forms, including but not limited to, non-volatile media, volatile media, and transmission media. Non-volatile media includes, for example, optical or magnetic disks, such as storage device 510. Volatile media includes dynamic memory, such as main memory 506. Transmission media includes coaxial cables, copper wire and fiber optics, including the wires that comprise bus 502. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying the above-described instructions to processor 504 to implement an embodiment of the type illustrated in FIGS. 3 and 4. For example, such instructions may initially be carried on a magnetic disk of a remote computer. The remote computer can load such instructions into its dynamic memory and send the instructions over a telephone line using a modem. A modem local to computer system 500 can receive such instructions on the telephone line and use an infra-red transmitter to convert the received instructions to an infra-red signal. An infra-red detector can receive the instructions carried in the infra-red signal and appropriate circuitry can place the instructions on bus 502. Bus 502 carries the instructions to main memory 506, in which processor 504 executes the instructions contained therein. The instructions held in main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. Local network 522 may interconnect multiple computers (as described above). For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network 528 now commonly referred to as the “Internet”. Local network 522 and network 528 both use electrical, electromagnetic or optical signals that carry digital data streams. The signals through the various networks and the signals on network link 520 and through communication interface 518, which carry the digital data to and from computer system 500, are exemplary forms of carrier waves transporting the information.

Computer system 500 can send messages and receive data, including program code, through the network(s), network link 520 and communication interface 518. In the Internet example, a server 530 might transmit a code bundle through Internet 528, ISP 526, local network 522 and communication interface 518. In accordance with the invention, one such downloaded set of instructions implements an embodiment of the type illustrated in FIGS. 3 and 4. The received set of instructions may be executed by processor 504 as received, and/or stored in storage device 510, or other non-volatile storage for later execution. In this manner, computer system 500 may obtain the instructions in the form of a carrier wave.

Numerous modifications and adaptations of the embodiments described herein will be apparent to the skilled artisan in view of the disclosure.

Accordingly numerous such modifications and adaptations are encompassed by the attached claims.

Several embodiments of the invention support the following six features each of which is believed to be novel over prior art known to the inventors.

A first new aggregate operator, (for the sake of name it is called XMLAgg( )), in CQL that converts a relational stream to an XML stream. This first operator is implemented as follows:
compile time: we build an aggregate function into the CQL operator tree
run time: for each item in the relational stream, we make an XML element node wrapping the item and append it into a result XML stream. When all the items from the input stream window is exhausted, we output the result XML stream.
optimizations at run time, is that when new items coming into a sliding window, we can delete the XML element nodes for the old data and add new XML element nodes for the new data.

A second new construct, (for the sake of name it is called XMLTable), in CQL that converts an XML stream to a relational stream. This second construct is implemented as follows:
compile time: we build an XMLTable row source the CQL operator tree. The row and column XQuery expressions in XMLTable construct is compiled by XQuery compiler and generate functions that will invoke XQuery run time engine.
run time: for each XML document in the XML stream, invoke the XQuery run time engine to process the XQuery expression defined in the row and converts the output of the XQuery engine, which is a sequence of items, into each row in the XMLTable row source. Then invoke XQuery run time engine for each column by taking the row output from the XMLTable row source.
An optimization of this implementation has been described above.

A third new transformation operator, (for the sake of name it is called XMLTransform( )), in CQL that applies XSLT on one XML stream and generate another XML stream. This third operator is implemented as follows:
compile time: we call XSLT compiler to compile the XSLT and build an XSLT transform function into the CQL operator tree
run time: for eachXML document in the XML stream, the XSLT transform function invokes an XSLT run time engine that applies XSLT on the input XML document and generate a new XML document into the output XML stream.

A fourth new query scalar value operator, (for the sake of name it is called XMLExtractValue( )), in CQL that applies an XQuery on one XML stream and generate a new scalar value for each item in the input XML stream. This fourth operator is implemented as follows:
compile time: we call XQuery compiler to compile the XQuery and build a query scalar value extraction function into the operator tree
run time: for each XML document in the XML stream, the query scalar value function invokes the XQuery run time engine and then takes the output of the XQuery value. If the output is a sequence of more than one item, it is error. If the output is a complex node, it is error. Otherwise, extracts the text content of the node and cast that into a scalar value type, such as number, date, in CQL.

A fifth new query operator, (for the sake of name it is called XMLQuery( )), in CQL that applies an XQuery on one XML stream and generate another XML stream. This fifth operator is implemented as follows:
compile time: we call XQuery compiler to compile the XQuery and build an XQuery function into the CQL operator tree
run time: for eachXML document in the XML stream, the XQuery transform function invokes an XQuery run time engine that applies XQuery on the input XML document and generate a new XML document into the output XML

A sixth new exist operator, (for the sake of name it is called XMLExists( )), in CQL that applies an XQuery on one XML stream and generate a boolean value for each item in the input XML stream.
compile time: we call XQuery compiler to compile the XQuery and build an XExists function into the CQL operator tree
run time: for eachXML document in the XML stream, the XExists function invokes an XQuery run time engine that applies XQuery on the input XML document. If the result from the XQuery run time engine is empty sequence, it generates Boolean false in the output stream. Otherwise, it generates true in the output stream.

Following attachments A and B are integral portions of the current patent application and are incorporated by reference herein in their entirety. Attachment A describes one illustrative embodiment in accordance with the invention. Attachment B describes a BNF grammar that is implemented by the embodiment illustrated in Attachment A.

### Attachment A

Following are some additional examples based on a stream of XML documents derived from stock trading. Each element tuple in the stream is an XML document describing a stock trading record with the following sample content:

TABLE 1
TradeRecord XML Document

```
<TradeRecord>
  <TradeID>34578</TradeID>
  <TradeSymbol>ORCL</TradeSymbol>
  <TradePrice>14.88</TradePrice>
  <TradeTime>2006-07-26:11:42</TradeTime>
  <TradeQuantity>456</Quantity>
</TradeRecord>
```

Users want to run the following set of CQL/XML queries on the data stream containing XML documents.

### Query 1:

Maintain a running count of the trading records on Oracle stock having price between $14.00 and $16.00 on the input XML stream with one hour window size sliding every 5 minute.

TABLE 2
XMLExists( ) usage in CQL/XML

SELECT RStream(count(*))
FROM StockTradeXMLStream AS sx [RANGE 1 Hour
SLIDES 5 minutes]
WHERE XMLExists(
‘/TradeRecord[TradeSymbol = “ORCL” and
TradePrice >= 14.00 and TradePrice <= 16.00]’
PASSING VALUE(sx))

This query uses XMLExists( ) operator which applies XQuery/XPath to the input XML document from the stream window. The input XML document is referenced as VALUE(sx) with sx being the alias of the input stream. If applying the XPath to the XML document returns non-empty sequence, then XMLExists( ) returns true and the XML document is counted. Otherwise, it is not counted.

The RStream( ) function, as defined in CQL means that the count value is streamed at each time instant regardless of whether its value has changed. If one applies IStream( ) instead of RStream( ) function, then the result will stream a new value each time the count changes.

### Query 2:

Select all the trading records whose trading quantity is more than 1000 and construct a new XML document stream by projecting out only TradeSymbol and TradeQuantity values. The input stream has one hour window size sliding every 5 minutes.

TABLE 3
XMLQuery( ) usage in CQL/XML

```
SELECT RStream(
  XMLQuery(‘<LargeVolumeTrade>{($tr/TradeID,
$tr/TradeSymbol,
$tr/TradeQuantity)}</LargeVolumeTrade>’
    PASSING VALUE(sx) AS “tr” RETURNING
CONTENT))
FROM StockTradeXMLStream sx [RANGE 1 Hour
SLIDES 5 minutes]
WHERE XMLExists(
  ‘/TradeRecord[TradeQuantity > 1000]’ PASSING
VALUE(sx))
```

In this query, we have used XMLExists( ) operator in the WHERE clause to filter the XML documents and then use XMLQuery( ) operator with embedded XQuery to construct a new XML document with root element LargeVolumeTrade containing only the TradeID, TradeSymbol and TradeQuantity sub-elements. XMLQuery( ) operator accepts an XQuery and input XML document as arguments and runs the XQuery and returns the XQuery sequence as the output. The RETURNING CONTENT option of XMLQuery( ) operator wraps the XQuery sequence result with a new document node as if the user had applied document{ } computed constructor on the XQuery result sequence.

### Query 3:

Maintaining a running minimum and maximum trading price for each symbol on the input stream with 4 hour window sliding every 30 minutes.

TABLE 4
XMLExtractValue( ) usage in CQL/XML

```
SELECT RStream(
XMLExtractValue(‘/TradeRecord/TradeSymbol’
PASSING
        VALUE(sx) AS VARCHAR(4)),
    min(XMLExtractValue(‘/TradeRecord/TradePrice’
PASSING
        VALUE(sx) AS DOUBLE)),
    max(XMLExtractValue(‘/TradeRecord/TradePrice’
PASSING
        VALUE(sx) AS DOUBLE)))
FROM StockTradeXMLStream  sx  [RANGE  4  Hour
SLIDES 30 minutes]
GROUP BY XMLExtractValue
(‘/TradeRecord/TradeSymbol’ PASSING
        VALUE(sx) AS VARCHAR(4))
```

In this query, we have used XMLExtractValue( ) which extracts a scalar value out of a simple XML element node using XPath and casts the scalar value into a SQL datatype. Although XMLExtractValue( ) is not defined in SQL/XML standard, it is merely a syntactic sugar of XMLCast(XMLQuery( )). That is,

```
XMLExtractValue(‘/TradeRecord/TradeSymbol’ PASSING
        VALUE(sx) AS VARCHAR(4))
is equivalent to
XMLCast(XMLQuery(‘/TradeRecord/TradeSymbol’ PASSING
VALUE(sx)
    RETURNING CONTENT) AS VARCHAR(4))
```

Having illustrated the intuitive examples of querying XML stream using XMLQuery( ), XMLExists( ), XMLExtractValue( ) operators, we now specify the formal semantics based on CQL and all the extensions to CQL to process XML.

CQL defines two concepts: stream and relation. A stream S is a bag of possibly infinite number of elements (S, T), where S is a tuple belonging to the schema of stream and T is the timestamp of the element. A relation R is a mapping from time T to a finite but unbounded bag of tuples, where each tuple belongs to the schema of the relation. A relation thus defines a bag of tuples at any time instance t.

Each tuple consists of a set of attributes (or columns), each of which is of the classical scalar SQL datatype, such as VARCHAR, DECIMAL, DATE, TIMESTAMP data type. To capture XML value, we allow the SQL datatype to be XML type. The XML type value defined in the SQL/XML is an XQuery data model instance. The XQuery data model instance is a finite sequence of items as defined in the XQuery. Thus an XML value is in general of XML(Sequence) type. There are two special but important subclasses of XML(Sequence), they are XML(Document) and XML(Content). XML(Document) is a sequence consisting of a single item which is a well formed XML document. XML(Content) is a sequence consisting of a single item of an XML document fragment with a document node wrapping the fragment.

CQL/XML, we don't extend XQuery data model to be XQuery sequence of infinite items because we are not extending XQuery to be a continuous XQuery. Furthermore, we don't allow an XML document to be decomposed into nodes which can arrive at the CQL/XML processor at different time. That is, intuitively, each XMLType value is completely captured in one tuple of the stream at each time instant. Doing so allows us to leverage the current language semantics of XQuery/XPath and XSLT in CQL without extending XQuery processing XQuery sequence of infinite items.

We define two special streams for CQL/XML. If the datatypes for all columns of a tuple in the stream are of classical scalar SQL datatypes, then we call such stream relational stream. If the tuple has only one column and that column is of XML(Sequence) type, then we call such stream a XML stream. Certainly there is mixed relational/XML stream where some columns of the tuple are of scalar SQL datatypes and others are XML(Sequence) type. Refer back to the examples in the previous section, we see that StockTradeXMLStream is an XML stream because each tuple of the stream is of XML(Document) type.

CQL defines three operators: Stream-to-Relation, Relation-to-Relation, Relation-to-Stream. These operators give precise semantic meaning of the CQL language querying and generating stream. Our XML extension to CQL (CQL/XML) does not require the change of these three operators either. However, some extensions are needed to deal with special aspects of XML values.

### Stream-to-Relation Operator

CQL uses the concept of window to produce finite number of tuples from potentially infinite number of tuples in a stream. Windows can be of any of the following types: time-based sliding window, tuple count based windows, windows with ‘slide’ parameter and partitioned windows. The partitioned window has partition by clause to allow user to specify how to split the stream into multiple sub-streams. We extend the partition by clause to allow XML operators, such as XMLExtractValue( ), used in the expression to partition single XML stream into multiple XML substreams. For example, one can partition StockTradeXMLStream by TradeSymbol as follows:

TABLE 5
XMLExtractValue( ) in PARTITION BY clause of CQL/XML

SELECT
Rstream(AVG(XMLExtractValue(‘/TradeRecord/TradePrice’
PASSING VALUE(xs) AS DOUBLE)))
FROM StockTradeXMLStream AS sx [PARTITION BY
XMLExtractValue(‘/TradeRecord/TradeSymbol’ PASSING
VALUE(sx) AS VARCHAR(4)) Rows 100]

Furthermore, some application may prefer to use “explicit timestamp”, which is provided as part of the tuple in the stream instead of “implicit timestamp”, which is the arriving order of the tuple in the stream. Again using XMLExtractValue( ) operator, such as XMLExtractValue(‘TradeRecord/TradeTime’ AS TIMESTAMP), can be a simple way of extracting explicit timestamp value out of the XML stream.

### Relation-to-Relation Operator

When the input stream is converted into input relation, then CQL essentially follows the semantics of SQL to produce new relation. Since there is XML type value in the stream, the relation converted from the stream has XML type value. This is valid in the context of SQL/XML which allows XML type columns in the relation. The semantics of Relation-to-Relation operator in CQL/XML follows the semantics of SQL/XML. This allows us to fully leverage existing SQL/XML, XQuery/XPath semantics without any modification of handling XML type value in the data stream.

### Relation-to-Stream Operator

In addition to RStream( ), CQL defines IStream( ) and DStream( ) for Relation-to-Stream operators. Informally, IStream( ) attempts to capture lately arrived tuples and DStream( ) attempts to capture lately disappeared tuples. Strictly speaking, the IStream( ) and DStream( ) rely on the relational MINUS operator which does relation MINUS on the relation computed on the current time instant T with the relation computed on the previous time instant T−1. The MINUS operator depends on how to distinguish two tuples. While for tuples of all classical simple SQL datatypes, the distinctness of them is well defined, the question arises on how to compare two XMLType values. SQL/XML currently prohibits DISTINCT, GROUP BY, ORDER BY, on XMLType values because it does not define how to compare two XMLType values. However, it is critical to define this for computing IStream( ) and DStream( ) as they are commonly used in CQL. We can use fn:deep-equal( ) function in XQuery to define how to compare two XMLType values by default. However, we shall give users the option to specify an expression for the IStream( ) and DStream( ) on deciding how to compare two tuples.

For example, If user issues IStream( ) on query shown in Table 3—XMLQuery( ) usage in CQL/XML, he can issue the following query to add DISTINCT BY clause to specify how to distinguish XMLType tuples in the resulting relation of one XMLType column. For example, the following query outputs only new large volume trading XML values, it compares two XML values by using value from TradeID sub-element.

TABLE 6
XMLExtractValue( ) in DISTINCT BY clause in CQL/XML

```
SELECT IStream(
  XMLQuery(‘<LargeVolumeTrade>{($tr/TradeID,
$tr/TradeSymbol,
$tr/TradeQuantity)}</LargeVolumeTrade>’
    PASSING  VALUE(sx)  AS  “tr”  RETURNING
CONTENT) AS ltx
    DISTINCT BY
    XMLExtractValue(‘/LargeVolumeTrade/TradeID’)
PASSING VALUE(ltx)
    AS NUMBER)
FROM StockTradeXMLStream  AS  sx  [RANGE  1  Hour
SLIDES 5 minutes]
WHERE XMLExists(
  ‘/TradeRecord[TradeQuantity  >  1000]’  PASSING
VALUE(sx))
```

### XSLT Transformation Operators in CQL/XML

As shown in previous examples, We have illustrated the usage of XMLQuery( ), XMLExists( ), XMLCast( ) operators in SQL/XML and have added the syntactic sugar XMLExtractValue( ) operator. All of these XML operators added into CQL/XML allow user to use XQuery/XPath to manipulate XMLType values in the data stream. Furthermore, to allow XSLT transformation, we add XMLTransform( ) operator that embeds XSLT inside operator to do XSLT transformation on the XMLType value from the data stream as shown below. This query essentially generates a stream of HTML documents of trading record that can be directly sent to browser for render.

TABLE 7
XMLTransform( ) operator in CQL/XML

```
SELECT XMLTransfom(
    ‘<?xml version=“1.0”?>
    <xsl:stylesheet  version=“1.0”
xmlns:xsl=“http://www.w3.org/1999/XSL/Transform”>
    <xsl:template  match=“/”><xsl:apply-
templates/></xsl:template>
    <xsl:template match=“TradeRecord”>
    <H1>TRADE RECORD</H1>
    <table  border=“2”>xsl:apply-
templates/></table></xsl:template>
    <xsl:template match = “TradeSymbol”>
    <tr>
      <td><xsl:value-of select=“TradeSymbol”/></td>
      <td><xsl:value-of select=“TradePrice”/></td>
    </tr>
    </xsl:template>
</xsl:stylesheet>’ PASSING VALUE(sx))
FROM StockTradeXMLStream  AS  sx  [RANGE  1  Hour
SLIDES 5 minutes]
```

Beyond this, we can add the SQL/XML XMLTable construct and SQL/XML publishing functions, such as XMLElement( ), XMLAgg( ), into CQL/XML so that user can convert relational stream to XML stream and vice versa. This will be discussed in the next two sections.

### Conversion of Relational Stream to XML Stream

SQL/XML has defined XMLElement( ), XMLForest( ) etc XML generation functions which generate XML from simple relational data. The following is an example of a relational stream StockTradeStream, consisting of trading records. Each tuple in the relational stream consists of TradeID, TradeSymbol, TradePrice, TradeTime, TradeQuantity columns. User can use XMLElement( ), XMLForest( ) functions to convert it into the StockTradeXMLStream that have been used in all the previous examples.

TABLE 8
XML Generation Function usage in CQL/XML

```
SELECT Rstream(XMLElement(“TradeRecord”,
    XMLForest(s.TradeID  as  “TradeID”,
s.TradeSymbol as “TradeSymbol”,
        s.TradePrice  as  “TradePrice”,  s.TradeTime
as “TradeTime”,
        s.TradeQuantity as “TradeQuantity”)))
FROM StockTradeStream  [RANGE  1  Hour  SLIDES 5
minutes] s
```

The input relational stream element and output XML stream element for the above CQL/XML query has one-to-one correspondence.

With XMLAgg( ), however, one can derive other XML stream from the relational stream without one-to-one correspondence.

Consider the following CQL/XML with the usage of XMLAgg( ) operator, it generates an hourlyReportXMLStream XML stream.

TABLE 9
XMLAgg( ) usage in CQL/XML

```
SELECT RStream(XMLElement(“HourlyTradeRecords”,
  XMLAgg(XMLElement(“TradeRecord”,
    XMLForest(s.TradeID  as  “TradeID”,
s.TradeSymbol as “TradeSymbol”,
        s.TradePrice  as  “TradePrice”,  s.TradeTime
as “TradeTime”,
        s.TradeQuantity as “TradeQuantity”)))))
FROM StockTradeStream  [RANGE  1  Hour  SLIDES  1
Hour] s
```

This CQL/XML generates an XML stream, each tuple in the stream is an XML document which captures all the trading record within last hour. Following is a sample of XML document in the tuple stream.

TABLE 10
HourlyTradeRecord XML document

```
<HourlyTradeRecords>
  <TradeRecord>
  <TradeID>34578</TradeID>
  <TradeSymbol>ORCL</TradeSymbol>
  <TradePrice>14.88</TradePrice>
  <TradeTime>2006-07-26:11:42</TradeTime>
  <TradeQuantity>456</Quantity>
  </TradeRecord>
  ....
  <TradeRecord>
  <TradeID>34578</TradeID>
  <TradeSymbol>IBM</TradeSymbol>
  <TradePrice>75.64</TradePrice>
  <TradeTime>2006-07-26:12:42</TradeTime>
  <TradeQuantity>556</Quantity>
  </TradeRecord>
</HourlyTradeRecords>
```

### XMLStream to Relational stream

Having shown relational stream as a base stream and XML stream as a derived stream, we now show XML stream as a base stream and the relational stream as a derived stream. For this, we use the XMLTable construct defined in SQL/XML XMLTable converts the XML value, which can be a sequence of items, into a set of relational rows. Even if the XML value is an XML document, user can use XQuery/XPath to extract sequence of nodes from the XML document and convert it into a set of relational rows. The first query shows an example of simple shredding of XMLType so that the base XML stream and derived relational stream still has one to one correspondence.

TABLE 11
XMLTable usage in CQL/XML

```
SELECT  RStream(s.TradeID,  s.TradeSymbol,
s.TradePrice, s.TradeTime, s.TradeQuantity)
FROM StockTradeXMLStream  AS  sx  [RANGE  1  Hour
SLIDES 5 minutes]
  XMLTable(‘/TradeRecord’ PASSING VALUE(sx)
      COLUMNS
        TradeID NUMERIC(32,0) PATH ‘TradeID’,
        TradeSymbol  VARCHAR2(4)  PATH
‘TradeSymbol’,
        TradePrice DOUBLE PATH ‘TradePrice’,
        TradeTime  TIMESTAMP  PATH
‘TradeTime’,
        TradeQuantity  INTEGER  PATH
‘TradeQuantity’) s
```

This query converts the XML stream StockTradeXMLStream into the relational stream StockTradeStream. The second query shown below illustrates an example of shredding XML stream so that the base XML stream and the derived relational stream do not have one to one correspondence. This shows how XMLTable can be leveraged to shred hierarchical XML structures in XML streams into master-detail-detail flat relational structure in relational stream. Recall that input stream hourlyReportXMLStream for this query is generated from StockTradeStream using XMLAgg( ) operator shown in table 9 and this query convert hourlyReportXMLStream back to StockTradeStream. This shows the inverse relationship of XMLAgg( ) and XMLTable. Such relationship is exploited for SQL/XML query rewrite.

TABLE 12
XMLTable usage in CQL./XML

```
SELECT  RStream(s.TradeID,  s.TradeSymbol,
s.TradePrice, s.TradeTime, s.TradeQuantity)
FROM hourlyReportXMLStream AS sx [RANGE 1 Hour
SLIDES 1 Hour],
  XMLTable(‘/HourlyTradeRecords/TradeRecord’
PASSING VALUE(sx)
      COLUMNS
        TradeID NUMERIC(32,0) PATH ‘TradeID’,
        TradeSymbol  VARCHAR2(4)  PATH
‘TradeSymbol’,
        TradePrice DOUBLE PATH ‘TradePrice’,
        TradeTime TIMESTAMP PATH ‘TradeTime’,
        TradeQuantity INTEGER PATH
‘TradeQuantity’) s
```

There are various published literatures on SQL extension to process data stream and many research prototyping systems. There are also papers on processing XML stream data. However, J. Chen's paper on NiagaraCQ does not propose XML extension to CQL kind of language, instead it focuses on XML-QL, an early version of XQuery. Also, the paper by S. Bose discusses query algebra for fragmented XML stream data. It views XML stream as a sequence of management chunks. This is basically an intra-XQuery Sequence Data Model stream instead of inter-XQuery Sequence Data Model that we propose here. We believe that eventually a continuous query extension to XQuery (CXQuery) will be proposed based on intra-XQuery Sequence Data Model. It will extend XQuery data model to have concept of streamed XQuery sequence (a sequence of infinite items with timestamp on each item). Furthermore, window functions can be applied on streamed XQuery sequence to get the current XQuery sequence of finite items.

Based on our SQL/XML development and deployment experience of Oracle XMLDB with large number of customer use cases, we believe that XML data stream processing and relational data stream will coexist in DBMS processing stream data just as both XML and relational data coexist in RDBMS today. This requires CQL extension to process XML stream besides continuous XQuery effort in the future. To our knowledge, we have not seen any proposal of applying SQL/XML features into a continuous query language, such as the CQL defined at Stanford University. Therefore, it is important for us to propose this so that streaming DBMS engine can consider this language alternative when processing XML data.

In this Attachment A, we have extended CQL with SQL/XML constructs to process XML data in a data stream. This extension fully leverages the semantics of SQL/XML, XQuery, XPath and XSLT to process XML in the data stream. It also provides native language constructs to act as a bridge between XML data stream and relational data stream. Although it is equally attractive to extend XQuery/XPath/XSLT directly to deal with XQuery data model with infinite items in the future, we believe it is important to call out the SQL/XML way of extending CQL as well and this does not preclude the future extension of XQuery to process XML data stream.

### Attachment B

BNF grammar for XML extension to CQL: (The bolded one is added for XML extension)

```
<value expression> ::=
    <XMLTransform Function Clause>
    <XMLExtractValue Function Clause>
    <XMLQuery Function Clause>
    <XMLExists Function Clause>
    <XMLElement Function Clause>
    <XMLAgg Function Clause>
<XMLTransform Function Clause> ::=
    XMLTransform (<value_expression>, ‘XSLT stirng literal’)
<XMLExtractValue Function Clause> ::=
    XMLExtactValue (<value_expression>, ‘XQuery stirng literal’ AS <scalar
type>)
<XMLQuery Function Clause> ::=
    XMLQuery (<value_expression>, ‘XQuery stirng literal’)
<XMLExists Function Clause> ::=
    XMLExists (<value_expression>, ‘XQuery stirng literal’)
<XMLElement Function Clause> ::=
    XMLElement(identifier, <value_expression>)
<XMLAgg Function Clause> ::=
    XMLAgg(<value_expression>)
<from clause> ::= FROM <stream reference> [{<comma> <stream reference>} ...]
                              [{ <comma> <XMLTable reference>} ...]
<XMLTable reference> :=
        XMLTABLE (‘XQuery string literal’ PASSING <value_expression> AS
identifier [<comma> <value_expression> AS identifier] ...
                        COLUMNS
                            <ColumnName> <columnType> PATH ‘PATH string
literal’
                          [{<comma> <ColumnName> <columnType> PATH
‘PATH string literal’} ...]
```

What is claimed is:

1. A computer-implemented method of processing streams of structured data using continuous queries in a data stream management system, the method comprising:
receiving a continuous query;
parsing the continuous query to identify an operator on data structured in accordance with a predetermined syntax;
inserting in a representation of the continuous query, a function to invoke a processor of structured data for said operator;
generating a plan, based on said representation, for execution of the continuous query including invocation of said processor; and
invoking the processor during execution of the continuous query using said plan, in response to receipt of said data in a stream of structured data.

2. The method of claim 1 further comprising:
parsing a path into structured data, said path being present in an operand of said operator;
creating a new source to supply scalar data extracted from the structured data;
generating an additional tree for an expression in the continuous query that operates on structured data, using scalar data supplied by said new source; and
modifying an original tree of operators that includes said operator, by linking the additional tree, thereby to yield a modified tree;
wherein the plan for execution of the query is generated based on the modified tree.

3. A carrier wave encoded with instructions to perform the acts of receiving, parsing, inserting, generating and invoking as recited in claim 1.

4. A computer-readable storage medium encoded with instructions to perform the acts of receiving, parsing, inserting, generating and invoking as recited in claim 1.

5. A computer-implemented method of processing streams of structured data using continuous queries in a data stream management system, the method comprising:
receiving a continuous query;
parsing the continuous query to identify an operator to convert an input stream of structured data into at least one output stream of scalar data;
inserting in a representation of the continuous query, a stream source representing said operator and having a row function and a column function;
generating a plan, based on said representation, for execution of the continuous query including invocation of a processor; and
invoking the processor during execution of the continuous query, in response to receipt of said data in a stream of structured data, by using the row function to process a path into structured data in said input stream, and using the column function to supply scalar data on said at least one output stream.

6. A computer-implemented method of processing streams of structured data using continuous queries in a data stream management system, the method comprising:
receiving a continuous query;
parsing the continuous query to identify an operator to convert an input stream of structured data into an output stream of structured data;
invoking a structured query compiler to compile the operator and build a transform function into an operator tree by applying a transformation to structured data;
linking to a tree representation of the continuous query, said operator tree obtained from said invoking to obtain a modified tree;
generating a plan, based on said modified tree, for execution of the continuous query including invocation of a processor; and
invoking the processor during execution of the continuous query, in response to receipt of structured data in said input stream to use the transform function to generate said output stream of structured data.

7. A computer-implemented method of processing streams of structured data using continuous queries in a data stream management system, the method comprising:
receiving a continuous query;
parsing the continuous query to identify an operator to extract a value from each tuple in an input stream of structured data and supply said value in a tuple in an output stream of scalar data;
inserting in a representation of the continuous query, a stream source representing said operator and having a value extraction function;
generating a plan, based on said representation, for execution of the continuous query including invocation of a processor; and
invoking the processor during execution of the continuous query, in response to receipt of said data in a stream of structured data, by using the value extraction function to supply said value on said output stream.
